(19) United States
(12) Patent Application Publication
(10) Pub. No.: US 2023/0339385 A1
(43) Pub. Date: Oct. 26, 2023

(54) Truck Bed Cargo Bag Device

(71) Applicant: Matthew Raver, Crockett, CA (US)

(72) Inventor: Matthew Raver, Crockett, CA (US)

(21) Appl. No.: 18/190,251

(22) Filed: Mar. 27, 2023

Related U.S. Application Data
(60) Provisional application No. 63/335,044, filed on Apr. 26, 2022.

(51) Int. Cl. B60P 7/04; B60P 7/08

(52) U.S. Cl. CPC B60P 7/04; B60P 7/0823

(57) ABSTRACT

The present invention relates to a truck bed cargo bag device for securing cargo within a pickup truck bed. The device has a bag-like body with an opening. Cargo within a pickup bed can be placed within the opening, wherein a fastener of the device may also allow a user to tighten the body of the device around the cargo. Then, the hook of the device can be secured to an anchor point of a pickup truck bed, and wherein the ratchet assembly can be used to shorten the strap and secure the device and cargo within the pickup truck bed.

### CROSS-REFERENCE TO RELATED APPLICATION

The present application claims priority to, and the benefit of, U.S. Provisional Application No. 63/335,044, which was filed on Apr. 26, 2022, and is incorporated herein by reference in its entirety.

### FIELD OF THE INVENTION

The present invention relates generally to the field of cargo-securing devices. More specifically, the present invention relates to a truck bed cargo bag device with a bag-like body with an opening. Cargo within a pickup bed can be placed within the opening, wherein a fastener of the device may also allow a user to tighten the body of the device around the cargo. Then, the hook of the device can be secured to an anchor point of a pickup truck bed, and wherein the ratchet assembly can be used to shorten the strap and secure the device and cargo within the pickup truck bed. Accordingly, the present disclosure makes specific reference thereto. Nonetheless, it is to be appreciated that aspects of the present invention are also equally applicable to other like applications, devices, and methods of manufacture.

### BACKGROUND

Transporting items like lumber, pipe, conduit, etc., in a pickup truck bed can be a difficult experience, especially when said items are longer than the truck bed. If a truck comes to an abrupt stop while transporting said items, the items can launch from the truck bed and cause serious injury to other motorists and vehicle damage. In order to prevent this, individuals transporting said items may utilize several straps, ratchets, etc., to keep just a few items secured in a truck bed. However, said devices may be unable to efficiently secure cargo within a pickup bed.

Therefore, there exists a long-felt need in the art for a device that can be used to secure cargo within a pickup truck bed. More specifically, there exists a long-felt need in the art for a truck bed cargo bag device that secures cargo items within a pickup truck bed. There also exists a long-felt need in the art for a truck bed cargo bag device that prevents cargo from falling from a truck bed during transport. In addition, there exists a long-felt need in the art for a truck bed cargo bag device that can attach to an existing anchor point within a truck bed.

The subject matter disclosed and claimed herein, in one embodiment thereof, comprises a truck bed cargo bag device. The device is primarily comprised of a body with at least one opening, at least one indicator, and at least one strap comprised of at least one hook and at least one ratchet assembly. The body of the device is comprised of a bag-like body with an opening, wherein cargo within a pickup bed can be placed within the opening. A fastener of the device may also allow a user to tighten the body of the device around the cargo. Then, the hook of the device can be secured to an anchor point of a pickup truck bed, and wherein the ratchet assembly can be used to shorten the strap and secure the device and cargo within the pickup truck bed.

In this manner, the truck bed cargo bag device of the present invention accomplishes all the foregoing objectives and provides a device that can be used to secure cargo within a pickup truck bed. More specifically, the truck bed cargo bag device of the present invention secures cargo items within a pickup truck bed and prevents said items from falling from a truck bed during transport. In addition, the device can easily attach to an existing anchor point within a truck bed.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a truck bed cargo bag device primarily comprised of a body with at least one opening, at least one indicator, and at least one strap comprised of at least one hook and at least one ratchet assembly. The body of the device is comprised of a bag-like body with an opening. The body is placed around the end of cargo located within a truck bed. The cargo is inserted into the opening of the body such that the body secures the cargo and binds the cargo together. In one embodiment, the opening may be tightened or loosened (i.e., become larger or smaller in circumference) around the cargo via at least one fastener.

The body may be comprised of at least one indicator that may be in the form of (but not limited to) a reflective flag, a bright-colored flag, a flashing LED, etc. The indicator and the color/material of the body serve to alert other drivers that the cargo is extending from the truck bed and to proceed with caution while behind the vehicle. The indicator may be any symbol, shape, and size known in the art. The indicator may also be comprised of at least one indicia such as, but not limited to, words, symbols, letters, phrases, etc.

The body is also comprised of at least one strap, wherein the first end of the strap is attached to the body. The second end of the strap is comprised of at least one hook. The strap is also comprised of a locking ratchet assembly that may be of the type found on any ratchet strap known in the art. During use, the hook can be attached to an anchor point within or on a truck bed, wherein the ratchet assembly can then be ratcheted to tighten the strap to further secure the cargo within (and push the cargo into) the truck bed.

The present invention may also be comprised of a method of use. First, a portion of cargo within a truck bed is placed within the opening of the body of the device. Then, the opening is tightened around the cargo via at least one fastener. Next, a hook of a strap of the device is secured to an anchor point of the truck bed. Then, the ratchet assembly of the strap can be tightened to shorten the strap and further secure the device to the anchor point.

Accordingly, the truck bed cargo bag device of the present invention is particularly advantageous as it can be used to secure cargo within a pickup truck bed. More specifically, the truck bed cargo bag device of the present invention secures cargo items within a pickup truck bed and prevents said items from falling from a truck bed during transport. In addition, the device can easily attach to an existing anchor point within a truck bed. In this manner, the truck bed cargo bag device overcomes the limitations of existing methods and devices used to secure cargo in a pickup truck bed that are known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a truck bed cargo bag device of the present invention while securing cargo in a truck bed in accordance with the disclosed architecture;

FIG. 2 illustrates a rear view of one potential embodiment of a truck bed cargo bag device of the present invention while securing cargo in a truck bed in accordance with the disclosed architecture;

FIG. 3 illustrates a top perspective view of one potential embodiment of a truck bed cargo bag device of the present invention in accordance with the disclosed architecture; and

FIG. 4 illustrates a flowchart of a method of using one potential embodiment of a truck bed cargo bag device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to secure cargo within a pickup truck bed. More specifically, there exists a long-felt need in the art for a truck bed cargo bag device that secures cargo items within a pickup truck bed. There also exists a long-felt need in the art for a truck bed cargo bag device that prevents cargo from falling from a truck bed during transport. In addition, there exists a long-felt need in the art for a truck bed cargo bag device that can attach to an existing anchor point within a truck bed.

The present invention, in one exemplary embodiment, is comprised of a truck bed cargo bag device primarily comprised of a body with at least one opening, at least one indicator, and at least one strap comprised of at least one hook and at least one ratchet assembly. The body of the device is comprised of a bag-like body with an opening, wherein the body can be placed around the end of cargo located within a truck bed. The cargo is inserted into the opening of the body such that the body secures the cargo and binds the cargo together. In one embodiment, the opening may be tightened or loosened (i.e., become larger or smaller in circumference) around the cargo via at least one fastener.

The body may be comprised of at least one indicator that may be in the form of (but not limited to) a reflective flag, a bright-colored flag, a flashing LED, etc. The indicator and the color/material of the body serve to alert other drivers that the cargo is extending from the truck bed and to proceed with caution while behind the vehicle. The indicator may be any symbol, shape, and size known in the art and may also be comprised of at least one indicia such as, but not limited to, words, symbols, letters, phrases, etc.

The body is also comprised of at least one strap, wherein the first end of the strap is attached to the body. The second end of the strap is comprised of at least one hook. The strap is also comprised of a locking ratchet assembly that may be of the type found on any ratchet strap known in the art. During use, the hook can be attached to an anchor point within or on a truck bed, wherein the ratchet assembly can then be ratcheted to tighten the strap to further secure the cargo within (and push the cargo into) the truck bed.

The present invention may also be comprised of a method of use. First, a portion of cargo within a truck bed is placed within the opening of the body of the device. Then, the opening is tightened around the cargo via at least one fastener. Next, a hook of a strap of the device is secured to an anchor point of the truck bed. Then, the ratchet assembly of the strap can be tightened to shorten the strap and further secure the device to the anchor point.

Accordingly, the truck bed cargo bag device of the present invention is particularly advantageous as it can be used to secure cargo within a pickup truck bed. More specifically, the truck bed cargo bag device of the present invention secures cargo items within a pickup truck bed and prevents said items from falling from a truck bed during transport. In addition, the device can easily attach to an existing anchor point within a truck bed. In this manner, the truck bed cargo bag device overcomes the limitations of existing methods and devices used to secure cargo in a pickup truck bed that are known in the art.

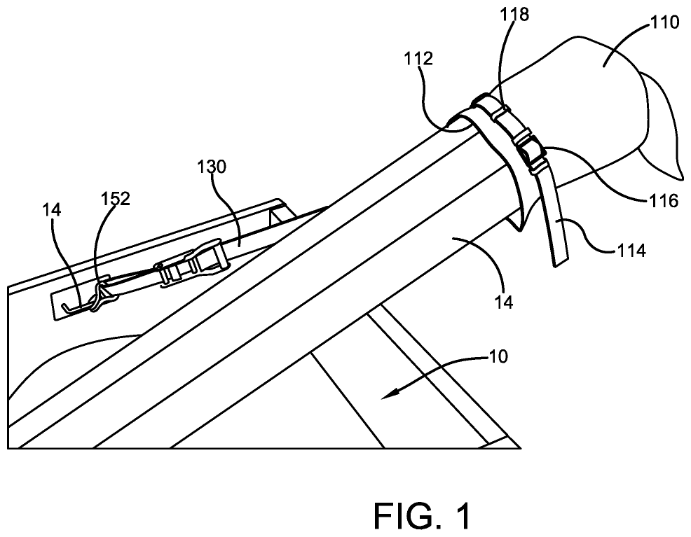

Referring initially to the drawings, FIG. 1 illustrates a perspective view of one potential embodiment of a truck bed cargo bag device 100 of the present invention while securing cargo 14 in a truck bed 10 in accordance with the disclosed architecture. The device 100 is primarily comprised of a body 110 with at least one opening 112, at least one indicator 120, and at least one strap 130 comprised of at least one hook 152 and at least one ratchet assembly 142. The body 110 of the device 100 is comprised of a bag-like body with an opening 112. The body 110 is preferably made from a tear-resistant, waterproof material. However, the body 110 may be made from any material that can withstand outdoor weather elements and puncturing known in the art.

The body 110 is placed around the end of cargo 14 located within a truck bed 10, wherein the cargo 14 is inserted into the opening 112 of the body 110. In this manner, the body 110 secures the cargo 14 and binds the cargo 14 together. In one embodiment, the opening 112 may be tightened or loosened (i.e., become larger or smaller in circumference) around the cargo 14 via at least one fastener 114 such as, but not limited to, a strap, a belt, a snap button, a hook and loop fastener, a magnet fastener, a tie, etc. In an embodiment wherein the fastener 114 is a strap, the strap may have at least one adjustment fastener 116 such as, but not limited to, a sliding buckle that allows the strap to shorten or lengthen in length. Further, an embodiment of the device 100 with a strap fastener 114 may be comprised of at least one loop 118 that secures the fastener 114 to the body 110. In this manner, the body 110 can be used to secure the cargo 14 together.

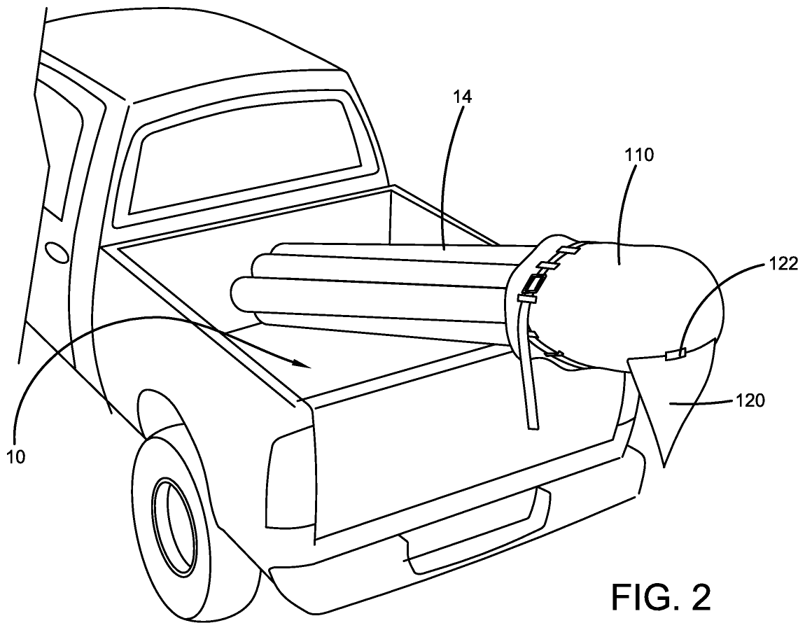

The body 110 may be made from a reflective material and/or a bright-colored material. In addition, the body 110 may be comprised of at least one indicator 120, as seen in FIG. 2. The indicator 120 may be in the form of (but not limited to) a reflective flag, a bright-colored flag, a flashing LED, etc. The indicator 120 and the color/material of the body 110 serve to alert other drivers that the cargo 14 is extending from the truck bed 10 and to proceed with caution while behind the vehicle. The indicator 120 may be any symbol, shape, and size known in the art. The indicator 120 may also be comprised of at least one indicia 124 such as, but not limited to, words, symbols, letters, phrases, etc. In one embodiment, the indicator 120 may be removably attached to the body 110 via at least one fastener 122 such as, but not limited to, hook and loop, magnet, adhesive, etc.

The body 110 is also comprised of at least one strap 130, wherein the first end 140 of the strap 130 is attached to the body 110. The second end 150 of the strap 130 is comprised of at least one hook 152. The hook 152 may be a locking hook 152 or any other hook type that is found on any style of ratchet strap known in the art.

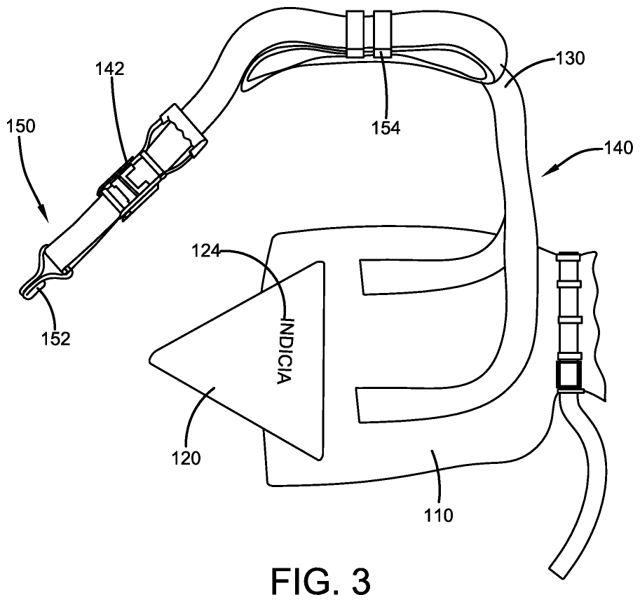

The strap 130 is also comprised of a locking ratchet assembly 142 that may be of the type found on any ratchet strap known in the art. Excess length of the strap 130 may be secured to itself via at least one strap fastener 154 that may be, but is not limited to, a hook and loop fastener, as seen in FIG. 3. This prevents excess portions of the strap 130 from leaving the truck bed 10 during transport.

During use, the hook 152 can be attached to an anchor point 12 within or on a truck bed 10. The ratchet assembly 142 can then be ratcheted to tighten the strap 130 to further secure the cargo 14 within (and push the cargo 14 into) the truck bed 10. In this manner, the cargo 14 cannot become easily dislodged from the trunk bed 10 during transport.

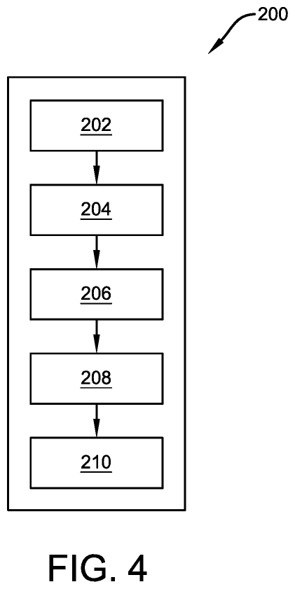

FIG. 4 illustrates a flowchart of a method of using 200 one potential embodiment of a truck bed cargo bag device 100 of the present invention in accordance with the disclosed architecture. The present invention may also be comprised of a method of use 200. First, a portion of cargo 14 within a truck bed 10 is placed within the opening 112 of the body 110 of the device 100 [Step 202]. Then, the opening 112 is tightened around the cargo 14 via at least one fastener 114 (and in one embodiment, also using an adjustment fastener 116) [Step 204]. Next, a hook 152 of a strap 130 of the device 100 is secured to an anchor point 12 of the truck bed 10 [Step 206]. Then, the ratchet assembly 142 of the strap 130 can be tightened to shorten the strap 130 and further secure the device 100 to the anchor point 12 [Step 208]. When a user has reached their destination, the strap 130 can be loosened via the ratchet assembly 142, the hook 152 can be removed from the anchor point 12, and the cargo 14 can be removed from the body 110 [Step 210].

Notwithstanding the internal references to a truck, it is contemplated that the truck bed cargo bag device 100 of the present invention can be used with any vehicle or trailer including, without limitation, a van, a car, an SUV, a bus, a semi-tractor, etc.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “truck bed cargo bag device” and “device” are interchangeable and refer to the truck bed cargo bag device 100 of the present invention.

Notwithstanding the foregoing, the truck bed cargo bag device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the truck bed cargo bag device 100 as shown in the FIGS. are for illustrative purposes only, and that many other sizes and shapes of the truck bed cargo bag device 100 are well within the scope of the present disclosure. Although the dimensions of the truck bed cargo bag device 100 are important design parameters for user convenience, the truck bed cargo bag device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A truck bed cargo bag device comprising:
a body comprised of an opening;
a fastener;
an indicator; and
a strap comprised of a hook and a ratchet assembly.

2. The truck bed cargo bag device of claim 1, wherein the fastener decreases a size of the opening.

3. The truck bed cargo bag device of claim 1, wherein the body is comprised of a reflective material.

4. The truck bed cargo bag device of claim 1, wherein the body is comprised of a waterproof material.

5. The truck bed cargo bag device of claim 1, wherein the body is comprised of a tear-resistant material.

6. The truck bed cargo bag device of claim 1, wherein a first end of the strap is attached to the body.

7. The truck bed cargo bag device of claim 1, wherein the hook is positioned at a second end of the strap.

8. A truck bed cargo bag device comprising:
a body comprised of an opening;
a fastener comprised of an adjustment fastener;
an indicator; and
a strap attached to the body, the strap comprised of a hook and a ratchet assembly.

9. The truck bed cargo bag device of claim 8, wherein the fastener is comprised of a strap.

10. The truck bed cargo bag device of claim 8, wherein the adjustment fastener is comprised of a sliding buckle.

11. The truck bed cargo bag device of claim 8, wherein the indicator is comprised of a reflective material.

12. The truck bed cargo bag device of claim 8, wherein the indicator is comprised of an indicia.

13. The truck bed cargo bag device of claim 12, wherein the indicia is comprised of a word, a symbol, a letter, or a phrase.

14. The truck bed cargo bag device of claim 8, wherein the indicator attaches to the body via an indicator fastener.

15. The truck bed cargo bag device of claim 8, wherein the indicator is comprised of a flag.

16. The truck bed cargo bag device of claim 8, wherein the body is comprised of a bright-colored material.

17. The truck bed cargo bag device of claim 8, wherein the body is comprised of a loop.

18. The truck bed cargo bag device of claim 17, wherein the fastener is positioned within the loop.

19. The truck bed cargo bag device of claim 8, wherein the hook is comprised of a locking hook.

20. A method of using a truck bed cargo bag device, the method comprising the steps of:
placing a cargo item in an opening of a body of a truck bed cargo bag device;
reducing the circumference of the opening around the cargo via a fastener;
hooking a strap of the truck bed cargo bag to an anchor point of a truck bed; and
tightening the strap using a ratchet assembly of the strap.
